(19) United States
(12) Patent Application Publication
(10) Pub. No.: US 2026/0201983 A1
(43) Pub. Date: Jul. 16, 2026

(54) AN ELONGATED WIRE ELEMENT FOR SUPPORTING A TENSILE LOAD, A FLEXIBLE PIPE BODY AND A METHOD OF PROVIDING A TENSILE ARMOUR WIRE

(71) Applicant: BAKER HUGHES ENERGY TECHNOLOGY UK LIMITED, Bristol (GB)

(72) Inventors: Fabio De Souza PIRES, Bristol (GB); Carlos Antonio De Carvalho RIBEIRO, Bristol (GB); Victor Pessanha TAMY, Bristol (GB); Fabio Pinheiro, Dos SANTOS, Bristol (GB); Ligia Yassuda DE MATTOS, Bristol (GB)

(21) Appl. No.: 19/137,120

(22) PCT Filed: Dec. 8, 2023
(86) PCT No.: PCT/EP2023/025514

§ 371 Date: Jun. 9, 2025

(30) Foreign Application Priority Data
Dec. 9, 2022 (GB) 2218555.7

(51) Int. Cl. F16L 11/08; C21D 8/06; C21D 9/52

(52) U.S. Cl. CPC F16L 11/083; C21D 8/06; C21D 9/52; C21D 2211/003; C21D 2211/005; C21D 2211/009

(57) ABSTRACT

An elongate wire element, flexible pipe body, and a method of providing a tensile armour wire are disclosed. The flexible pipe body is for transportation of a production fluid which comprises a tubular fluid retaining layer and at least one armour layer coaxial with the fluid retaining layer. Each armour layer comprises at least one helically wound elongate metal alloy body that comprises at least two phases that are disposed in a lamellar structure with lamellae in each bi-crystal grain colony in a cross section of the metal alloy body being directionally orientated between 90° and 60° to a one predetermined direction.

The present invention relates to a method and apparatus for supporting tensile loads where they may occur to help prevent failure in a structural element. In particular, but not exclusively, the present invention relates to the orientating of lamella, present in the microstructure of a metal alloy body of tensile wires, in a direction which impedes the growth of stress corrosion cracks.

Wires of various kinds are used in many industries to support tensile loads. These wires may be made of metals, alloys, composites, or other materials suitable for carrying tensile loads. Some wires carry predominantly static loads whilst others have a significant dynamic component of loading. Tensile wires may be located in a range of environments which can have a varied effect on the wire. For example, tensile wires in bridges are exposed to moisture, sulphur, and a level of carbon dioxide in the atmosphere along with other chemicals.

Many materials including plastic and glass but particularly metals and alloys are vulnerable to stress corrosion cracking (SCC). SCC is a process involving the initiation of cracks and their propagation in a material, sometimes leading to catastrophic failure, at a stress lower than the ultimate tensile strength of the material. SCC occurs in a given material because of a combination of an applied tensile load and a corrosive environment. In other words, for a given corrosive environment and applied tensile load, one material will allow stress corrosion cracks to propagate whilst another may not. In an alloy, the proportion of different elements and the microstructure affect the threshold for SCC propagation.

Metallic wires are also used in flexible pipes. Flexible pipes are a type of heavy-duty pipe used to transport fluids in challenging environments. An example of a challenging environment is 1000 m below sea level, although it will be understood that flexible pipes may be used onshore or further below sea level or in shallow waters. Flexible pipes often use metallic wires to improve the structural rigidity of the pipe. Tensile wires in particular are used to reinforce the pipe in long, unsupported sections where the self-weight of the pipe adds a significant strain. Tensile wires are therefore exposed to high levels of stress in potentially corrosive environments.

Flexible pipes are widely used in the oil and gas industry in offshore applications for the transportation of oil, gas, water, or other fluids from one location to another. Flexible pipe is particularly useful in connecting sea-level supporting structures and subsea locations (which may be deep underwater, say 1000 metres or more), where the pipe may act as a riser. A flexible pipe is generally formed as an assembly of flexible pipe body and one or more end fittings. Flexible pipe body may have an internal diameter of typically up to around 0.6 metres (e.g. diameters may range from 0.05 m up to 0.6 m). Due to their location, flexible pipes are exposed to a range of challenging conditions that may have high pressures, seawater, high tensile strain, and corrosive environments. Flexible pipe body is therefore composed of several concentric polymeric, metallic, and/or composite layers. For example, pipe body may include polymer and metal layers, or polymer and composite layers, or polymer, metal and composite layers. Layers may be formed from a single piece such as an extruded tube or by helically winding one or more wires at a desired pitch or by connecting together multiple discrete hoops that are arranged concentrically side-by-side. Depending upon the layers of the flexible pipe used and the type of flexible pipe some of the pipe layers may be bonded together or remain unbonded. The polymeric layers generally provide sealing from fluid ingress and the metallic layers structural rigidity.

Some flexible pipes have been used for deep water (less than 3,300 feet (1,005.84 metres)) and ultra-deep water (greater than 3,300 feet) developments. It is the increasing demand for oil which is causing exploration to occur at greater and greater depths (for example in excess of 8202 feet (2500 metres)) where environmental factors are more extreme. For example, in such deep and ultra-deep water environments, ocean floor temperature increases the risk of production fluids cooling to a temperature that may lead to pipe blockage. In practice, flexible pipes are conventionally designed to perform at operating temperatures of −30° C. to +130° C. and pipe body are being developed for even more extreme temperatures. Increased depths also increase the pressure associated with the environment in which the flexible pipe must operate. For example, a flexible pipe may be required to operate with external pressures ranging from 0.1 MPa to 30 MPa acting on the pipe. Equally, transporting oil, gas or water may well give rise to high pressures acting on the flexible pipe from within, for example with internal pressures ranging from zero to 140 MPa from bore fluid acting on the pipe. As a result, the need for high levels of performance and environmental resilience from certain layers such as a pipe carcass or a pressure armour or a tensile armour layer of the flexible pipe body is increased. It is noted for the sake of completeness that flexible pipe may also be used for shallow water applications (for example less than around 500 metres depth) or even for shore (overland) applications.

The innermost layers of flexible pipe body often include an inner sheath which can be an extruded non-porous polymer layer that confines a bore fluid to its internal circumference, and often a carcass, a spirally wound interlocking metal structure which forms the very innermost layer. The carcass prevents the collapse of the inner liner and also protects the liner from abrasive particles. When a carcass layer is present in the flexible pipe body, the inner sheath is referred to as a barrier layer. When a carcass layer is not present in the flexible pipe body, the inner sheath is referred to as a liner.

The outermost layer of a flexible pipe is the outer sheath, an extruded non-porous polymer layer that protects the pipe's structural elements from the environment around the flexible pipe and prevents the ingress of seawater.

The annulus of a flexible pipe is the region between the innermost fluid containing layer and the outermost fluid containing layer. The innermost layers in this annulus region are pressure armour layers, which are made of helically wound flattened metallic wires arranged at a lay angle close to 90°. Neighbouring wound wires in the pressure armour layer interlock to control the gap between windings. Pressure armour is designed to withstand hoop stress in the pipe wall, which is caused by the bore fluid pressure. Pairs of tensile armour layers are also located in the annulus, and these are cross-wound radially outside the pressure armour layer. Tensile armour layers are often made of slightly flattened rectangular metallic wires arranged at a lay angle of about 30-55°. Tensile armour layers support the weight of all internal pipe layers and transfer the resulting tensile stress to the sea-level supporting structures. The annulus may also have other layers such as anti-wear and anti-birdcaging tapes, and thermally insulating layers. Carbon steel wires in the annulus are thus often a feature of flexible pipes for subsea environments.

Conventionally, carbon steel wires in the annulus are vulnerable to stress corrosion cracking (SCC) caused by corrosive gases such as CO₂ and H₂S. Such gases can enter the annulus and create a corrosive environment. The gases typically enter the annulus through seawater breaching flaws in the outer sheath although they can also enter the annulus by permeating through the inner polymer sheath from bore fluid containing dissolved corrosive gases. The most common cause of SCC in flexible pipe is a riser operating in a high-CO₂ subsea environment.

Stress corrosion cracks nucleate and propagate at tensile stresses far below the yield stress of a material due to a corrosive environment. SCC can induce cracking and even catastrophic failure of the metallic wires of a flexible pipe. It is therefore a constant aim to improve the resistance of flexible pipes to SCC. It is known that three conditions need to be present simultaneously for SCC to occur: a corrosive environment, a high-strength material that is crack-susceptible, and a high tensile stress exceeding a critical level. Consequently, the tensile armour layers of a flexible pipe are most vulnerable to SCC.

It is an aim of the present invention to at least partly mitigate one or more of the above-mentioned problems.

It is an aim of certain embodiments of the present invention to orientate lamellae in a metal alloy body in a predetermined direction.

It is an aim of certain embodiments of the present invention to orientate lamellae in a metal alloy body in a predetermined direction that is orthogonal to an expected crack initiation surface region.

It is an aim of certain embodiments of the present invention to orientate a bi-crystal structure of a structural element that is used to bear tensile load whereby the orientated bi-crystal structure is provided to redirect a crack propagation direction relative to how such propagation might be expected.

It is an aim of certain embodiments of the present invention to orientate lamellae in tensile armour wires in a predetermined direction.

It is an aim of certain embodiments of the present invention to align lamellae in tensile armour wires with the tensile armour wire axis and load direction.

It is an aim of certain embodiments of the present invention to provide apparatus for helping to control crack propagation.

It is an aim of certain embodiments of the present invention to provide apparatus for helping to control the direction of crack propagation.

It is an aim of certain embodiments of the present invention to provide apparatus for helping to control the rate of crack propagation.

It is an aim of certain embodiments of the present invention to improve wires in relation to Stress Corrosion Cracking in CO₂ (SCCCO₂).

It is an aim of certain embodiments of the present invention to provide apparatus for helping to control the direction of crack propagation due to Stress Corrosion Cracking in CO₂ (SCCCO₂).

It is an aim of certain embodiments of the present invention to provide a method for orientating lamellae in a metal alloy body in a predetermined direction.

It is an aim of certain embodiments of the present invention to provide a method for orientating lamellae in a metal alloy body in a predetermined direction relative to a direction of an expected crack initiation surface region.

According to a first aspect of the present invention there is provided an elongate wire element for supporting a tensile load at a structure, comprising:
an elongate metal alloy body comprising at least one outer surface region, that is an expected crack initiation surface region, locatable where crack propagation is expected when the metal alloy body supports a tensile load; wherein the metal alloy body is manufactured from a metal alloy that comprises at least two phases that are disposed in a lamellar formation with lamellae in each bi-crystal colony in a cross section of the metal alloy body being directionally oriented between 90° and 60° to a one predetermined direction that is parallel to a plane that contains said a cross section and in a direction orthogonal to the expected crack initiation surface region.

Aptly, the elongate wire element comprises, in any selected cross section along the body, at least 60% of an area of all regions of at least a first phase of the metal alloy extend between 90° and 60° to the predetermined direction.

Aptly, the elongate wire element further comprises, in any selected cross section along the body, at least 60% of an area of at least 60% of all lamellae of the same phase in each colony extend along a common direction of orientation.

Aptly, the predetermined direction is a direction orthogonal to a wire drawing direction and the metal alloy body is a body manufactured via a pre-drawing and/or a cold drawing.

Aptly, the metal alloy body comprises a plurality of colonies in each respective cross section at any selected point along said length and each colony in a cross section comprises material in a parallelised lamellar orientation.

Aptly, the metal alloy is an alloy that comprises two stable phases at a temperature of between 30° C. to minus 3° C.

Aptly, the metal alloy is an iron-carbon alloy comprising Iron (Fe) and Carbon (C) and optionally one or more alloying elements.

Aptly, each bi-crystal colony is a pearlite colony.

Aptly, each bi-crystal colony comprises alternating regions of a cementite phase (Fe₃C), which comprises a first phase of the metal alloy, and a ferrite (alpha phase) which comprises a further phase of the metal alloy.

Aptly, each lamellae in a cross section comprises an elongate region of a material that has a uniform composition.

Aptly, the metal alloy body is a cold rolled body.

Aptly, the elongate wire element further comprises an average misorientation angle of each phase is less than 30°.

According to a second aspect of the present invention there is provided a flexible pipe body for transportation of a production fluid, comprising:
a tubular fluid retaining layer; and
at least one armour layer coaxial with the fluid retaining layer; wherein each armour layer comprises at least one helically wound elongate metal alloy body that comprises at least two phases that are disposed in a lamellar structure with lamellae in each bi-crystal colony in a cross section of the metal alloy body being directionally orientated between 90° and 60° to a one predetermined direction.

Aptly, the armour layer comprises a first tensile armour layer that comprises a first plurality of discreet helically wound metal alloy wires that each comprise an elongate metal alloy body, each metal alloy wire in said first plurality of wires being disposed with lamellae in each bi-crystal colony, in a cross section orthogonal to a primary axis of the wire, being directionally oriented between 90° and 60° to said a one predetermined direction that comprises a direction aligned with a radial direction that is a direction directly radially outwards away from a central primary axis of the flexible pipe body.

Aptly, lamellae in each colony in any cross section in any wire of the first plurality of wires of the first armour layer have commonly aligned lamellae that share a direction of orientation within 30° of each other.

Aptly, the at least one armour layer comprises a further tensile armour layer that comprises a further plurality of discreet helically wound metal alloy wires with the lamellae in a cross section of each of the further plurality of wires that provide the further armour layer also commonly aligned whereby lamellae in each colony in any cross section along a length of a respective wire in the further plurality of wires being aligned within 30° to one another.

Aptly, the metal alloy of the wires in the first armour layer comprise lamellae directionally oriented in each colony in any cross section along a length of a respective wire that have a direction of orientation within 30° of one another and that share a common direction of orientation with the lamellae in the wires of the further armour layer.

According to a third aspect of the present invention there is provided a method of providing a tensile armour wire for flexible pipe body, comprising the steps of:
providing a pre-drawn bar of a metal alloy;
urging the metal alloy of the pre-drawn bar via a die member thereby providing an elongate cold drawn tensile armour wire; and
varying at least one manufacturing parameter during the step of providing a pre-drawn bar and/or urging the metal alloy whereby the cold drawn wire element comprises a metal alloy that comprises at least two phases that are disposed in a lamella formation with lamellae in each bi-crystal colony in a cross section of the wire element being directionally oriented between 90° and 60° to a one predetermined direction that is aligned with a direction that comprises a direction of drawing.

Aptly, the method further comprises varying at least one manufacturing parameter by varying a strain of a metal alloy body during a pre-drawing step that provides the pre-drawn bar and/or varying a strain of a metal alloy body during the step of urging the metal alloy of the pre-drawn bar via a die member.

Aptly, the method further comprises varying at least one manufacturing parameter by varying a localised temperature applied to a metal alloy body during a pre-drawing step and/or urging a pre-drawn bar via a die member.

Certain embodiments of the present invention provide additional control of the lamellar microstructure of metal alloys.

Certain embodiments of the present invention provide an improved wire in relation to Stress Corrosion Cracking in CO₂ (SCCCO₂).

Certain embodiments of the present invention provide a higher energy level for the SCC cracks to propagate than the energy level required for the crack to propagate through the grains containing spheroidized cementite.

Certain embodiments of the present invention provide a method that helps to control the direction of crack propagation.

Certain embodiments of the present invention provide a method for promoting the preferential alignment of lamellae to a wire axis.

Certain embodiments of the present invention provide apparatus with improved resistance to crack propagation.

Certain embodiments of the present invention provide apparatus that have a lamellar microstructure in which the lamellae are orientated in a predetermined direction.

Certain embodiments of the present invention provide apparatus for deviating a crack to a direction which could reduce the stress intensity factor in a crack tip, slowing down crack propagation or even permanently arresting it.

Certain embodiments of the present invention help redirect a crack propagation direction away from what would otherwise be expected. The redirection routes cracks in a direction away from a direction across a smallest dimension of a cross section of the elongate wire element that is used as a structural element to support tensile loads. This reduces a likelihood of failure in the wire element.

Certain embodiments of the present invention provide apparatus that helps mitigate effects of Stress Corrosion Cracking in CO₂ (SCCCO₂).

Embodiments of the present invention will now be described hereinafter, by way of example only, with reference to the accompanying drawings in which:

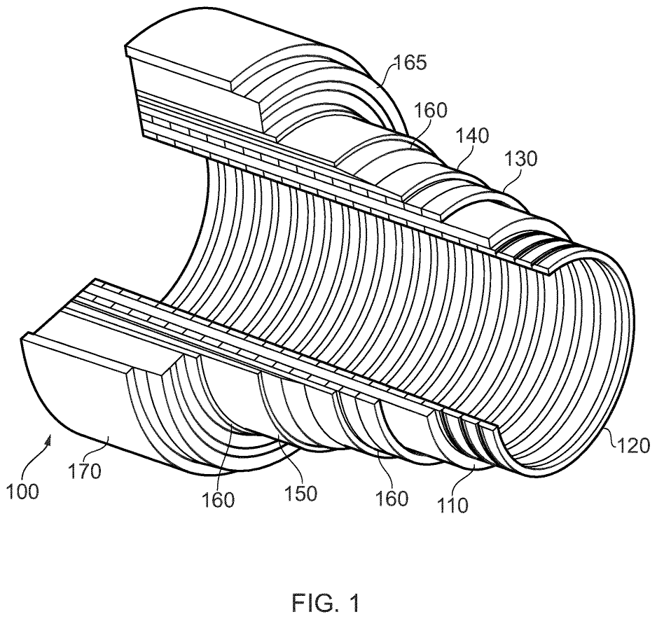

FIG. 1 illustrates flexible pipe body;

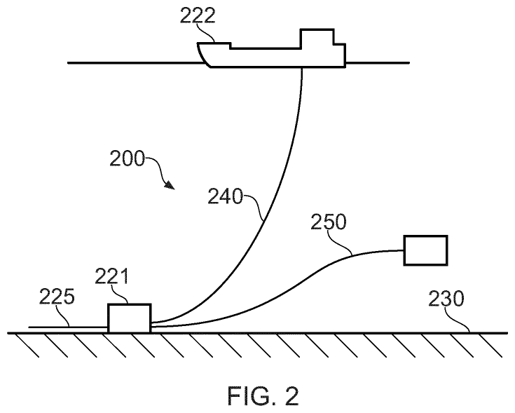

FIG. 2 illustrates certain uses of flexible pipe;

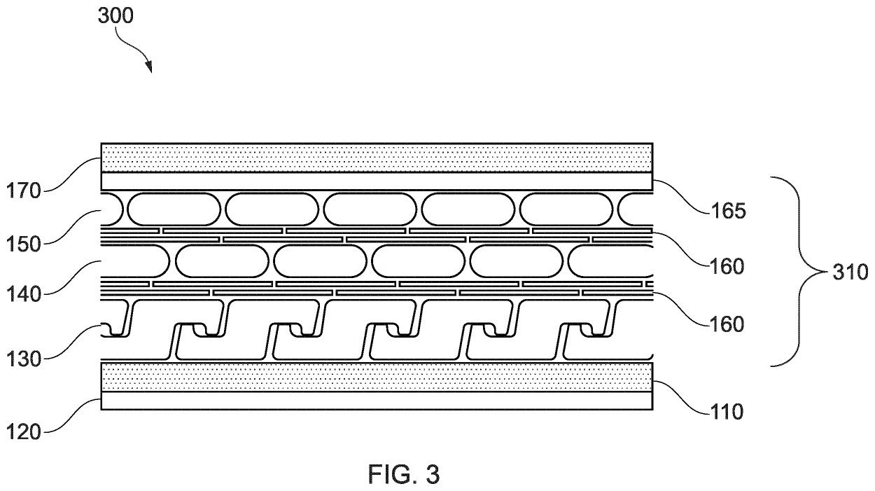

FIG. 3 illustrates a section view of flexible pipe body;

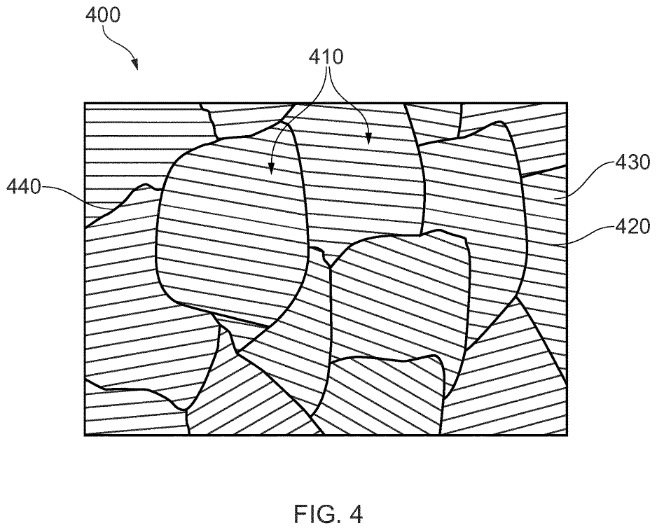

FIG. 4 illustrates a carbon steel lamellar microstructure;

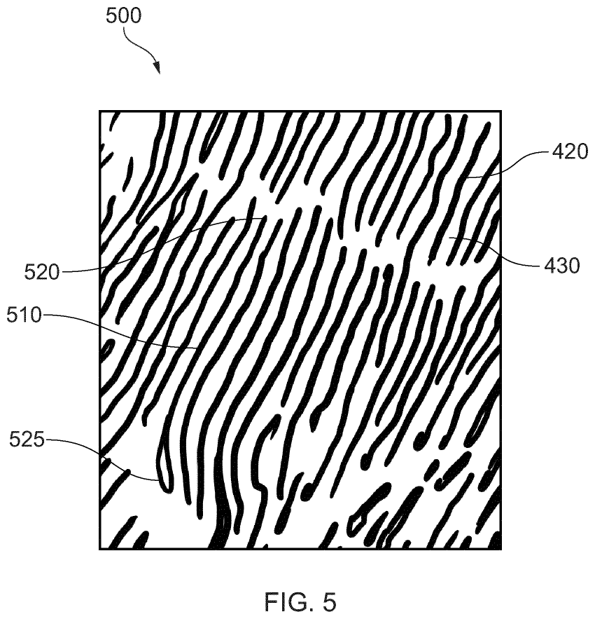

FIG. 5 illustrates a 0.6% wt carbon steel sample microstructure;

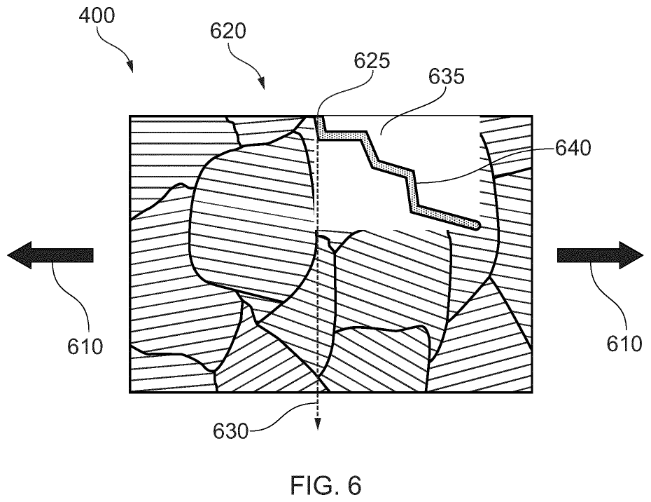

FIG. 6 illustrates crack propagation in a microstructure with orientated lamellae;

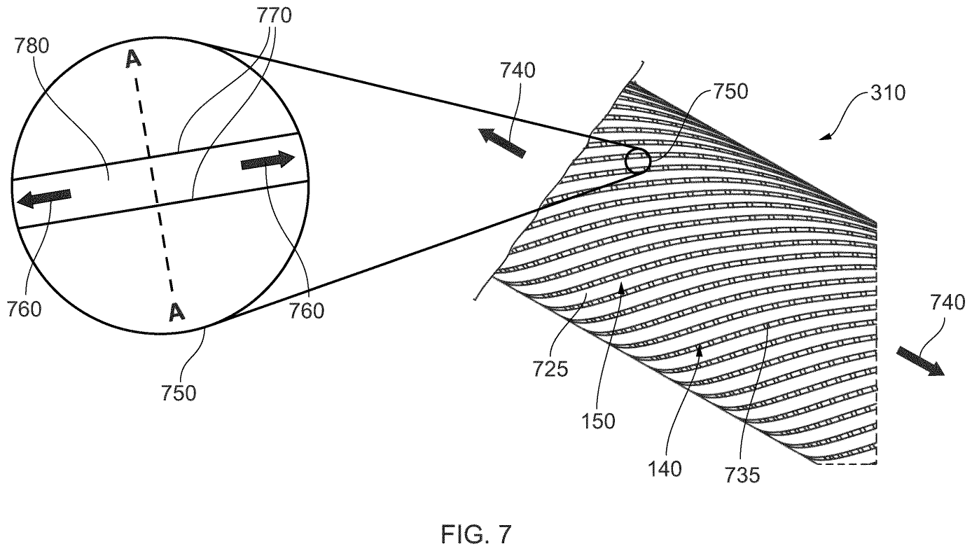

FIG. 7 illustrates a section of flexible pipe body with tensile armour wires exposed;

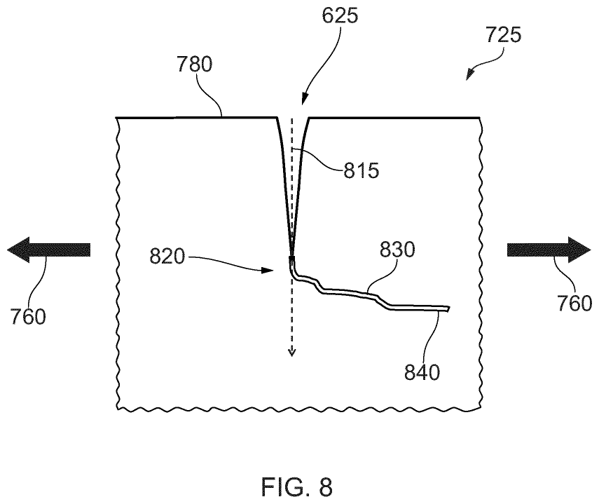

FIG. 8 illustrates an element of the tensile armour wire;

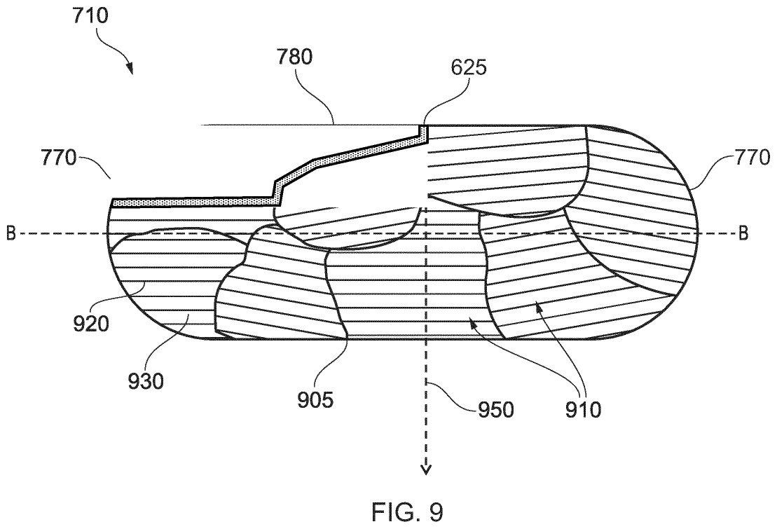

FIG. 9 illustrates crack propagation through a cross section of tensile armour wire;

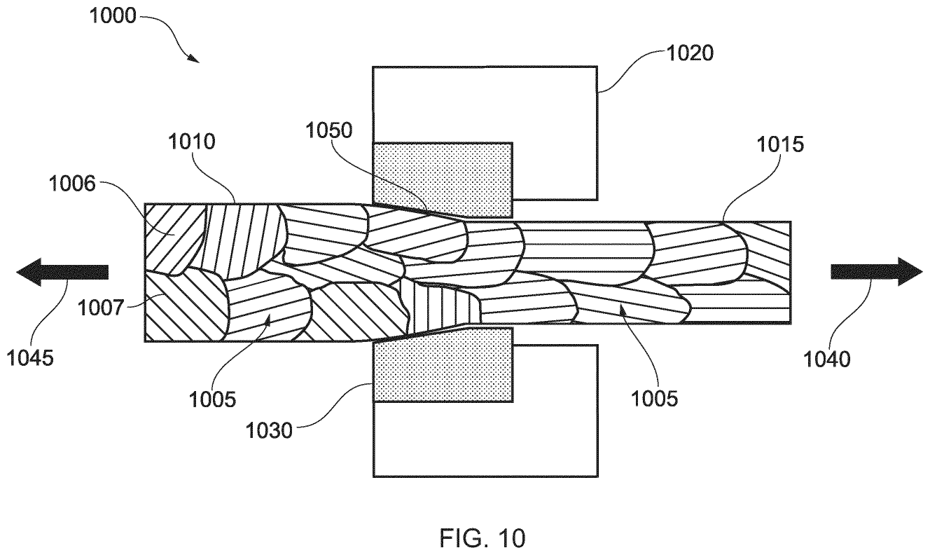

FIG. 10 illustrates a method of aligning lamellae;

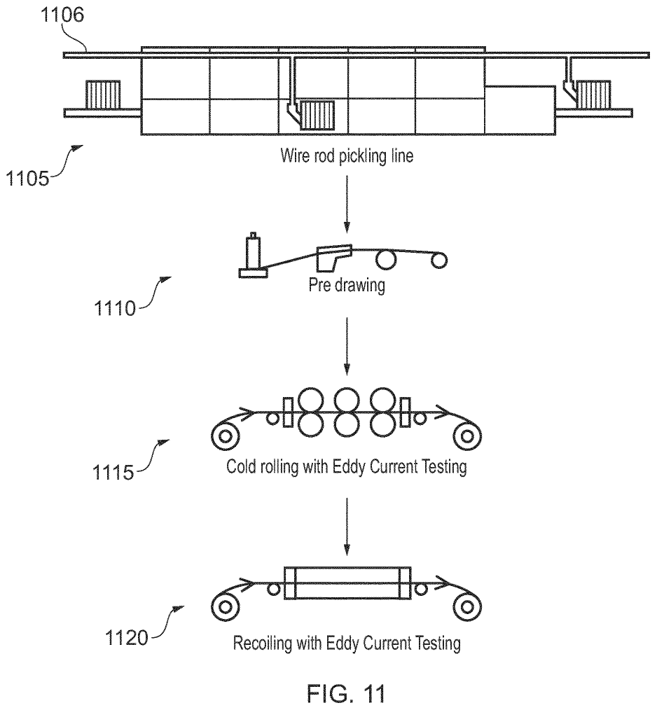

FIG. 11 illustrates a manufacturing process for metallic wires with orientated lamellar microstructure;

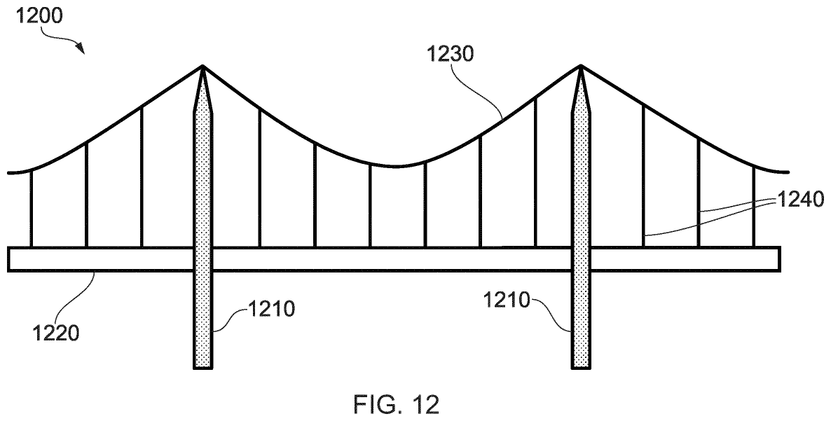

FIG. 12 illustrates an alternative use for elongate wire elements; and

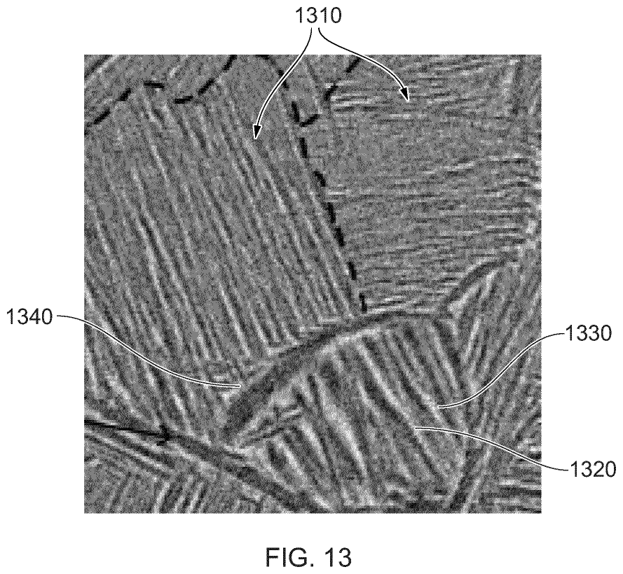

FIG. 13 illustrates a different alloy with a lamellar microstructure.

In the drawings like reference numerals refer to like parts.

Throughout this description reference will be made to an elongate wire element for use in a flexible pipe. It will be appreciated that certain embodiments of the present invention are applicable to different uses of a wire used to support tensile loads.

Likewise, throughout this description, reference will be made to a flexible pipe. It is to be appreciated that certain embodiments of the present invention are applicable to use with a wide variety of flexible pipe. For example certain embodiments of the present invention can be used with respect to flexible pipe body and associated end fittings of the type which is manufactured according to API 17J. Such flexible pipe is often referred to as unbonded flexible pipe. Other embodiments are associated with other types of flexible pipe.

It will be understood that the illustrated flexible pipes are an assembly of a portion of flexible pipe body and one or more end fittings (not shown) in each of which a respective end of the pipe body is terminated. FIG. 1 illustrates how pipe body 100 is formed from a combination of layered materials that form a pressure-containing conduit. As noted above although a number of particular layers are illustrated in FIG. 1, it is to be understood that certain embodiments of the present invention are broadly applicable to coaxial pipe body structures including two or more layers manufactured from a variety of possible materials. The pipe body may include one or more layers comprising composite materials, forming a tubular composite layer. It is to be further noted that the layer thicknesses are shown for illustrative purposes only. As used herein, the term “composite” is used to broadly refer to a material that is formed from two or more different materials, for example a material formed from a matrix material and reinforcement fibres.

A tubular composite layer is thus a layer having a generally tubular shape formed of composite material. Alternatively, a tubular composite layer is a layer having a generally tubular shape formed from multiple components one or more of which is formed of a composite material. The layer or any element of the composite layer may be manufactured via an extrusion, pultrusion or deposition process, or by a winding process in which adjacent windings of tape which themselves have a composite structure are consolidated together with adjacent windings. The composite material, regardless of manufacturing technique used, may optionally include a matrix or body of material having a first characteristic in which further elements having different physical characteristics are embedded. That is to say elongate fibres which are aligned to some extent or smaller fibres randomly orientated can be set into a main body or spheres or other regular or irregular shaped particles can be embedded in a matrix material, or a combination of more than one of the above. Aptly the matrix material is a thermoplastic material, aptly the thermoplastic material is polyethylene or polypropylene or nylon or PVC or PVDF or PFA or PEEK or PTFE or alloys of such materials with reinforcing fibres manufactured from one or more of glass, ceramic, basalt, carbon, carbon nanotubes, polyester, nylon, aramid, steel, nickel alloy, titanium alloy, aluminium alloy or the like or fillers manufactured from glass, ceramic, carbon, metals, buckminsterfullerenes, metal silicates, carbides, carbonates, oxides or the like.

The pipe body 100 illustrated in FIG. 1 includes an internal pressure sheath 110 which acts as a fluid retaining layer and comprises a polymer layer that ensures internal fluid integrity. The layer provides a boundary for any conveyed fluid. It is to be understood that this layer may itself comprise a number of sub-layers. It will be appreciated that when a carcass layer 120 is utilised the internal pressure sheath is often referred to by those skilled in the art as a barrier layer. In operation without such a carcass (so-called smooth bore operation) the internal pressure sheath may be referred to as a liner. A barrier layer 110 is illustrated in FIG. 1.

It is noted that a carcass layer 120 is a pressure resistant layer that provides an interlocked construction that can be used as the innermost layer to prevent, totally or partially, collapse of the internal pressure sheath 110 due to pipe decompression, external pressure, and tensile armour pressure and mechanical crushing loads. The carcass is a crush resistant layer. It will be appreciated that certain embodiments of the present invention are thus applicable to ‘rough bore’ applications (with a carcass). Aptly the carcass layer is a metallic layer. Aptly the carcass layer is formed from stainless steel, corrosion resistant nickel alloy or the like. Aptly the carcass layer is formed from a composite, polymer, or other material, or a combination of materials and components. The carcass layer is usually radially positioned within the barrier layer.

The carcass layer is a “layer” in the sense that a radially innermost and outermost surface are created in single pass at a single manufacturing node. The single manufacturing node may include multiple tape handling sections axially close together so that they are effectively a single node. The node aptly extends over an axial distance of less than 2.5 m. Aptly the node has a length of 1 m or less.

The pipe body includes a pressure armour layer 130 that is a pressure resistant layer that provides a structural layer that increases the resistance of the flexible pipe to internal and external pressure and mechanical crushing loads. The layer also structurally supports the internal pressure sheath. Aptly as illustrated in FIG. 1 the pressure armour layer is formed as a tubular layer. Aptly for unbonded type flexible pipe the pressure armour layer consists of an interlocked construction of wires with a lay angle close to 90°. Aptly in this case the pressure armour layer is a metallic layer. Aptly the pressure armour layer is formed from carbon steel, aluminium alloy or the like. Aptly the pressure armour layer microstructure consists of orientated lamellae. Aptly the pressure armour layer is formed from a pultruded composite interlocking layer. Aptly the pressure armour layer is formed from a composite formed by extrusion or pultrusion or deposition. A pressure armour layer is positioned radially outside an underlying barrier layer.

The flexible pipe body also includes a first tensile armour layer 140 and second tensile armour layer 150. Each tensile armour layer is used to sustain tensile loads and optionally also internal pressure. Aptly for some flexible pipes the tensile armour windings are metal (for example steel, stainless steel or titanium or the like). For some composite flexible pipes the tensile armour windings may be polymer composite tape windings (for example provided with either thermoplastic, for instance nylon, matrix composite or thermoset, for instance epoxy, matrix composite). For unbonded flexible pipe the tensile armour layer is formed from a plurality of wires (to impart strength to the layer) that are located over an inner layer and are helically wound along the length of the pipe at a lay angle typically between about 10° to 55°. Aptly the tensile armour layers are counter-wound in pairs. Aptly the tensile armour layers are metallic layers. Aptly the tensile armour layers are formed from carbon steel, stainless steel, titanium alloy, aluminium alloy or the like. Aptly the tensile armour layers have a microstructure that consists of orientated lamellae. Aptly the tensile armour layers are formed from a composite, polymer, or other material, or a combination of materials.

Aptly the flexible pipe body includes optional layers of tape 160 which help contain underlying layers and to some extent prevent abrasion between adjacent layers. The tape layer may optionally be a polymer or composite or a combination of materials, also optionally comprising a tubular composite layer. Tape layers can be used to help prevent metal-to-metal contact to help prevent wear. Tape layers over tensile armours can also help prevent “birdcaging”.

The flexible pipe body also includes optional layers of insulation 165 and an outer sheath 170, which comprises a polymer layer used to protect the pipe against penetration of seawater and other external environments, corrosion, abrasion and mechanical damage. Any thermal insulation layer helps limit heat loss through the pipe wall to the surrounding environment.

Each flexible pipe comprises at least one portion, referred to as a segment or section, of pipe body 100 together with an end fitting located at at least one end of the flexible pipe. An end fitting provides a mechanical device which forms the transition between the flexible pipe body and a connector. The different pipe layers as shown, for example, in FIG. 1 are terminated in the end fitting in such a way as to transfer the load between the flexible pipe and the connector.

FIG. 2 illustrates a riser assembly 200 suitable for transporting production fluid such as oil and/or gas and/or water from a sub-sea location 221 to a floating facility 222. For example, in FIG. 2 the sub-sea location 221 includes a sub-sea flow line 225. The flexible flow line 225 comprises a flexible pipe, wholly or in part, resting on the sea floor 230 or buried below the sea floor and used in a static application. The floating facility may be provided by a platform and/or buoy or, as illustrated in FIG. 2, a ship. The riser assembly 200 is provided as a flexible riser, that is to say a flexible pipe 240 connecting the ship to the sea floor installation. The flexible pipe may be in segments of flexible pipe body with connecting end fittings.

It will be appreciated that there are different types of riser, as is well-known by those skilled in the art. Certain embodiments of the present invention may be used with any type of riser, such as a freely suspended (free-hanging, catenary riser), a riser restrained to some extent (buoys, chains), totally restrained riser or enclosed in a tube (I or J tubes). Some, though not all, examples of such configurations can be found in API 17J. FIG. 2 also illustrates how portions of flexible pipe can be utilised as a jumper 250.

FIG. 3 illustrates a longitudinal section view of a portion of flexible pipe body 300. The bottom of the figure shows the innermost layer of the flexible pipe forming the inner radius. The top of the figure shows the outermost layer of the flexible pipe forming the outer radius. Consequently, the region below the bottom layer is in direct contact with a bore fluid flowing through the flexible pipe and the region above the top layer is in direct contact with the environment surrounding the flexible pipe such as a subsea environment. As the carcass is not fluid tight the radially innermost surface of the barrier layer 110 effectively defines the bore passage.

The flexible pipe body 300 shown in FIG. 3 includes all of the layers detailed in FIG. 1 such as the barrier layer 110, the carcass 120 and the outer sheath 170. The region between the sheaths 110, 170 is called an annulus 310 and primarily offers structural support for the flexible pipe along with optional features such as thermal insulation. The annulus 310 includes the pressure armour layer 130, tape layers 160, the pair of opposing helically wound first and second tensile armour layers 140, 150 illustrated and the insulating layer 165. The tensile armour layers 140, 150, are made from a metal alloy. The metal alloy is a carbon steel. The carbon steel has a pearlite microstructure (not shown). The pearlite microstructure has lamellae that are broadly orientated in one direction (not shown). This direction is favourable for inhibiting crack propagation from tensile forces. Similarly, the pressure armour layer 130 is made from a metal alloy. The metal alloy has a microstructure in which lamellae are broadly orientated in one direction (not shown). This direction is favourable for inhibiting crack propagation from tensile forces. Other metal alloys that have a lamellar phase for the respective component parts could of course be used.

The second tensile armour layer 150 is one of the outermost layers of the annulus 310, second to the insulating layer 165. In some embodiments, it will be appreciated that the tensile armour layer 150 will be the outermost layer of the annulus, thus directly in contact with the outer sheath 170. Consequently, any fluid ingress into the annulus due to damage to the outer sheath 170 will soon come into contact with the tensile armour layers 150, 140. The tensile armour layers 150, 140 are also under large tensile stress. In a high CO₂ environment, the tensile armour layers are vulnerable to stress corrosion cracking.

FIG. 4 illustrates the microstructure of an alloy of carbon steel in a two-dimensional view of a section 400 of the alloy. The alloy constitutes a plurality of pearlite colonies 410. Each colony 410 in the alloy is a bi-crystal that has a first crystal of a first phase 420 and further crystal of a further phase 430, where a phase means a region with a uniform composition. That is to say the phase is chemically and physically uniform. The first phase 420 and further phase 430 are interpenetrating crystals that appear in any two-dimensional cross section to be arranged in alternating elongate substantially parallel regions that may be referred to as layers. It will be appreciated by a person skilled in the art that the bi-crystal colony may be a crystal colony. The layers of the first phase 420 and further phase 430 in a given colony 410 have a common orientation along their longest dimension. In other words, the colony 410 has a single crystallographic orientation. There are boundaries 440 between neighbouring colonies 410, which have different crystallographic orientations.

The first phase 420 is cementite (Fe₃C) also known as iron carbide. The further phase 430 is ferrite (α-Fe), an allotrope of pure iron with a body-centred cubic (BCC) crystal structure. It will be appreciated that in other embodiments, a different lamellar spacings may be present in the alloy. It will be appreciated that in other embodiments, a different alloy with different colonies and phases may be used. For example, an Al-based alloy that also has a lamellar microstructure substantially identical to the microstructure shown in FIG. 4.

In FIG. 4, the crystallographic orientation of each colony 410 is similar. That is to say that all of the lamellae in the alloy in FIG. 4 are generally orientated in a particular direction. In FIG. 4, the particular direction is horizontal. It will be appreciated that in other embodiments, the particular direction of orientation of lamellae may be different.

FIG. 5 illustrates the microstructure of a sample 500 of 0.6% wt carbon steel. The lamellar structure of pearlite colonies is visible as alternating light and dark elongate substantially parallel regions. The elongate substantially parallel regions may also be referred to as layers. In the embodiment, the layers have an aspect ratio length: width of at least 8:1. The pearlite colonies have layers of the first phase 420, wherein the first phase is cementite (Fe₃C), and the further phase 430, wherein the further phase is ferrite (α-Fe). It will be appreciated that in other embodiments the first phase 420 and further phase 430 may be phases of a different alloy that also has a lamellar structure, for example a TiAl-Nb alloy.

The sample 500 has a number of layers 510. The layers are of the first phase 420 and the further phase 430. Each layer 510 has a first end 520 and a further end 525. In the sample 500 the majority of lamellae 510 are orientated in a predetermined direction rather than being randomly orientated. In other words, the layers of the first phase 420 and further phase 430 are generally aligned in one direction. The layers within a pearlite colony are generally aligned in one direction. Additionally, orientation of the layers in different pearlite colonies are generally aligned in one direction.

In FIG. 5, at least 60% of an area of all regions of at least the first phase 420 of the metal alloy extend between 90° and 60° to the predetermined direction. In other words, over 60% of the first phase 420 is misaligned by less than 30% from a defined direction. It will be appreciated that in other embodiments, said an area of 60% of all lamellae may be higher or lower. It will be appreciated that in other embodiments the misalignment of 30% may be higher or lower. It will be appreciated that the orientation of layers in a predetermined direction in a sample may be defined as at least 60% of an area of at least 60% of all lamellae of the same phase in each colony extend along a common direction of orientation.

Alternatively, the orientation of an individual lamella of the first phase may be found by considering the line of displacement from the first end 520 to the further end 525. Therefore, in the sample 500, at least 60% of lamellae are misoriented by less than 30% to a given direction.

FIG. 6 illustrates crack propagation in a microstructure with orientated lamellae. The microstructure of a carbon steel in a two-dimensional section of the alloy is shown. This may be the same section 400 of the alloy shown in FIG. 4 having orientated lamellae, where the lamellae are alternating layers of the first phase and further phase of the alloy.

The carbon steel alloy in the section 400 is exposed to a tensile force 610 illustrated by the arrows. The tensile force acts outwards to the left and right of the figure respectively. At a surface 620 of the carbon steel alloy, there is a crack nucleation site 625. It will be appreciated that a crack may nucleate anywhere when the tensile force is of sufficient magnitude. It will also be appreciated that a flaw in the surface of the material may act as a crack nucleation site. Such a surface flaw could be a machining mark, a pre-existing crack, pit or intergranular corrosion or the like.

The crack in the section 400 initially starts to propagate in a direction 630 that is orthogonal to the tensile force 610. This provides the maximum stress concentration at the crack tip. As the crack propagates, it reaches a layer of the first phase 635. The layer 635 is orientated in a predetermined direction that is generally parallel to the direction of the tensile force 610. This predetermined direction may be referred to as the preferred direction of the crack. The crack proceeds to propagate along the layer of the first phase 635, which provides an easier route for crack propagation. Occasionally the crack may deviate 640 from the preferred direction but the overall actual crack propagation direction is deflected towards the preferred direction. Additionally, the longer path taken by the crack indicates that the crack resistance of the material is also improved by the orientation of lamella in a predetermined direction.

FIG. 7 illustrates a section of flexible pipe body with tensile armour wires shown exposed. That is to say the outer sheath of the flexible pipe body is removed in FIG. 7 so that the outer layers of the annulus 310 are visible. The outermost layer of the annulus 310 is a first tensile armour layer 150. The first tensile armour layer 150 is made from a number of first tensile armour layer wires 725 that are wound in a counter-clockwise direction at a lay angle of around 55° . Underneath the first tensile armour layer 150 is a further tensile armour layer 140. The further tensile armour layer 140 is made from a number of further tensile armour wires 735 that are wound in a clockwise direction at a lay angle of around 55°. It will be appreciated that in other embodiments, the lay angle of wires 725, 735 may be between 10° and 55°. The first and further tensile armour wires are made from a carbon steel. The carbon steel has a pearlite microstructure with lamellae orientated in a predetermined direction (not shown).

The section of flexible pipe body shown is under a tensile force 740 due at least to the weight of the flexible pipe body and bore fluid. The first and further tensile armour layers 150, 140 help the flexible pipe body to withstand the tensile force. The tensile force acts through the central axis of the first tensile armour layer 150. Similarly, the tensile force also acts through the central axis of the further tensile armour layer 140.

Part of one of the first tensile armour wires 725 is shown in more detail via expanded circle 750. The first tensile armour wire 725 is subjected to a tensile force 760 which acts through the central axis of the wire 725. The first tensile armour wires 725 are tape-shaped. That is to say the wires 725 have a width many times greater than their thickness (into the page). Consequently, when the first tensile armour wires are subjected to a sufficient tension force 760, a crack will nucleate from a side surface 770 or a top surface 780 or a bottom surface (not shown) along a plane A-A orthogonal to the applied tension force 760.

FIG. 8 illustrates an element of the tensile armour wire 725. The element is located at some length along the wire such that the top surface 780 of the wire is at the top of the figure and the bottom surface of the wire (not shown) is an indeterminate depth below the top surface. The body of the tensile armour wire 725 is made from pearlite. The pearlite has a lamellar microstructure in which the lamellae are orientated in a predetermined direction (not shown). The wire element is subject to the tensile force 760 outwards to the left and right of FIG. 8. The wire element may be located in a high CO₂ environment. It will be appreciated by a person skilled in the art that the high CO₂ environment, when combined with the tensile force 760, may increase the vulnerability of the carbon steel tensile armour wire 725 to stress corrosion cracking. Certain embodiments of the present invention are of course usable when a non-corrosive environment is to be expected.

In FIG. 8, a stress corrosion crack has nucleated from the top surface 780 at the crack nucleation site 625 and begun to propagate. It will be appreciated by a person skilled in the art that a stress corrosion crack could nucleate from any location. For example, a stress corrosion crack could nucleate anywhere along the surface of the tensile armour wire 725. It will be appreciated that a stress corrosion crack may nucleate at a surface flaw such as a machining mark, pre-existing crack, pit or a site of inter-colony corrosion.

The stress corrosion crack beginning at the nucleation site 625 propagates in a direction 815 perpendicular to tension force. The direction 815 is also perpendicular to the central axis (not shown) of the tensile armour wire 725. A crack propagating from a surface 780 in the direction 815 across the thickness of the wire 725 will have the least distance to propagate before reaching the opposite surface.

At a point (location) 820 the stress corrosion crack begins to propagate in a direction other than the path perpendicular to tension 815 which is otherwise predicted by crack mechanics. The stress corrosion crack continues to propagate 830 in a sideways direction. In the embodiment shown, the direction is generally aligned with the direction of the tension force. It will be appreciated by a person skilled in the art that deflecting crack propagation away from the shortest length (thickness) may also be achieved when the direction is into or out of the page. In other words, a crack that is propagating across the thickness of the tensile armour wire 725 may be deflected across the width of the tensile armour wire. At a crack tip 840, the crack continues to propagate in a direction generally parallel to the tension force.

FIG. 8 thus helps illustrate how lamellae in bi-crystal colonies may thus be aligned/directionally oriented orthogonal to or generally orthogonal to (between 90° and 60° to) a one single predetermined direction. That predetermined direction is parallel to (or generally parallel to) a plane that contains a cross section through the wire element and is a direction orthogonal to an expected crack initiation surface region.

FIG. 9 illustrates a cross section of a wire where the cross section is a plane orthogonal to the central axis of the wire. The wire may be one of the first tensile armour wires 150 shown in FIG. 7. It will be appreciated that a cross section can be taken anywhere along the length of the tensile armour wire 150. It will be appreciated that in another embodiment, the wire could be for a different purpose such as a tension cable in a bridge. It will be appreciated that in another embodiment, the wire may have a different cross section. The tensile armour wire 150 has a top surface 780, side surfaces 770 and a bottom surface 905. Aptly the cross section of the wire element is the same all along a length of the structural element.

The wire shown in FIG. 9 is an alloy with a number of colonies 910. In each colony there are regions of a first phase 920 and regions of a further phase 930. These regions are elongate substantially straight areas which may be referred to as lamellae. The alternating lamellae of the first phase 920 and further phase 930 are orientated in one direction within a colony. The orientation of the colony may be referred to as the crystallographic orientation. The lamellae in different colonies are broadly orientated in a common direction indicated by the line B-B. At least 60% of an area of at least 60% of all lamellae of the same phase in each colony extend along a common direction of orientation.

The tensile armour wire 150 illustrated in FIG. 9 is exposed to a tensile force. The tensile force acts into the page and out of the page. In other words, the tensile force acts orthogonally to the plane containing the cross section of the tensile armour wire 150. When the tensile armour wire is exposed to a combination of a high CO₂ environment and a sufficient tensile force, stress corrosion cracking may be expected to occur at an exposed surface of the tensile armour wire 150.

The stress corrosion crack nucleates at a crack nucleation site 625. It will be appreciated that the stress corrosion crack can nucleate from any location on the surface. It will be appreciated that the stress corrosion crack may nucleate from a flaw in the surface of the tensile armour wire such as a machining mark, a pre-existing crack, a pit or intergranular corrosion. Due to the tensile force applied to the tensile armour wire, the crack will propagate in a direction orthogonal to the tensile force. In other words, the crack can propagate in any direction on the plane of the cross section. The shortest distance from the crack nucleation site through the centre of the cross section to the other side is along the vertically downwards line 950 towards the bottom surface 905.

The crack propagates along the lamella of the first phase 920. It will be appreciated that in other embodiments, the crack may propagate along the lamella of the further phase 930. The path along the lamella provides a less resistant path for the crack to propagate compared to the downwards line 950. Optionally the crack propagates along an interface region between adjacent phases. Consequentially to the orientation of the lamellae in a common direction B-B, the crack propagation is deflected away from the shortest path to failure and into a different dimension.

FIG. 10 illustrates a method of aligning lamellae in a metal alloy using a drawing process 1000. The metal alloy undergoing a drawing process has a number of colonies 1005 with a lamellar microstructure made of alternating layers of a first phase 1006 and a further phase 1007. On the left of the figure a bar 1010 made of the metal alloy is entered into the drawing process, leaving as a drawn bar 1015 with orientated lamellae. The bar may be a certain grade of carbon steel with favourable properties for orientating lamellae. It will be appreciated that in some embodiments, the bar 1010 may already have partially orientated lamellae. For example, the bar may have been partially orientated by a directional solidification process or by another earlier drawing process. The method illustrated in FIG. 10 increases the alignment of lamellae in a lamellar microstructure towards a predetermined direction. In other words, after the drawing process 1000 the lamellae are more aligned with the predetermined direction than they were before the process.

The drawing process 1000 has a housing 1020 in which a die 1030 may be secured. The die may be made from a carbide. The housing may be formed from two parts where one part is above the bar and one part is below the bar. Similarly, the die may be a two-piece structure. During the process, a forward drawing force 1040 is applied. A back tension 1045 may also be added. Consequentially, a stress is applied to the pre-drawn bar 1000. As the pre-drawn bar 1000 passes through the die, the bar is deformed by an approach 1050 which defines a smaller dimension that that of the pre-drawn bar 1000.

The drawing process deforms the bar 1010 reducing one dimension of the bar and increasing a different dimension. Consequently, the colonies 1005 in the alloy are also lengthened in the direction of the forward drawing force 1040. The total volume of material is conserved. The change in dimension of the bar in its axial direction is known as the strain.

The deformation of colonies 1005 affects the lamellae within the colony. Lamellae which are close in orientation to the drawing direction 1040 are further aligned in the drawing direction 1040. Lamellae which are substantially misaligned from the drawing direction become curled and are re-formed in alignment with the drawing direction 1040. When the bar is subjected to a strain such that the bar deforms by at least a threshold stress, the majority of the lamellae within the bar 1010 are aligned in a predetermined direction as defined by the drawing direction 1040.

In the drawing process 1000, the lamellae of the first phase 1006 of the bar 1010 are orientated in a predetermined direction by using a specific reduction rate which produces the drawn bar 1015 with orientated lamellae. The drawing process 1000 may involve a bar 1010 of a specific metal alloy grade. The metal alloy grade may be chosen to improve the effectiveness of the drawing process 1000 in orientating lamellae in a predetermined direction. It will be appreciated by a person skilled in the art that a specific strain of the metal alloy body can be specified instead of the specific reduction rate.

FIG. 11 illustrates a manufacturing process for metallic wires with orientated lamellar microstructure. The manufacturing process includes a first manufacturing stage 1105 involving pickling a wire bar 1106. The wire bar is made from a metal alloy with a lamellar microstructure. A second manufacturing stage 1110 is a pre-drawing stage. During the pre-drawing stage, the wire bar 1106 is drawn through a die by a minimum drawing force (not shown). The resulting wire has a reduced cross-sectional diameter and improved mechanical properties. The pre-drawing stage may help to orientate lamellae in the wire bar in a predetermined direction. The pre-drawing stage may be the drawing process described in FIG. 10.

A third manufacturing stage 1115 is a cold rolling with eddy current testing stage. The third manufacturing stage involves rolling the pre-drawn wire from the second manufacturing stage 1110 at room temperature. Eddy current testing is a quality testing process which involves using electrical probes with current passing through to test a material for cracks, particularly crack hidden under the surface. In an embodiment, the heat treatment process involves stress relief. In another embodiment, the heat treatment process involves an annealing step. In another embodiment, the heat treatment process involves a slow cooling treatment. A fourth manufacturing stage involves recoiling wire manufactured in the previous stages into a spool for convenient storage and transport.

FIG. 12 illustrates an alternative use for elongate wire elements. Wire elements for supporting a tensile load at a structure may be used as tension cables in a bridge. A suspension bridge 1200 has metallic or metal alloy components. The suspension bridge also 1200 has towers 1210 that are loaded in compression. The towers 1210 may be made from reinforced concrete or another suitable material for loading in compression. A deck 1220, which includes a stiffening girder (not shown) provides a surface for the bridge 1200 to offer utility. For example, some bridges allow passengers to cross the deck 1220 whilst other bridges support vehicles such as cars on the deck 1220. The suspension bridge 1200 is exposed to an environment containing levels of potentially corrosion-enhancing chemicals such as CO₂ and SO₂. The suspension bridge 1200 may be exposed to emissions from vehicles. The environment and emissions may contain chemicals which affect the rate of corrosion of metal or metal alloy materials used in the suspension bridge 1200.

The suspension bridge 1200 has a main suspension cable 1230 that is supported by the towers 1210 and anchorage points on land each side of the bridge (not shown). The suspension bridge 1200 also has vertical suspenders 1240 which transfer load from the deck 1220 to the main suspension cable 1230. The main suspension cable 1230 and the vertical suspenders 1240 are loaded in tension. The environment that the cables are in may contain levels of chemicals that increase the rate of stress corrosion cracking. The cables are particularly vulnerable to stress corrosion cracking due to the high tensile load that the cables are subjected to. The suspension cable is made of a metal alloy. The metal alloy has a lamellar microstructure. The lamellae in the lamellar structure of the suspension cable are orientated along the line of axial symmetry of the suspension cable. The predetermined orientation of lamellae in the main suspension cable increases its resistance to stress corrosion cracking. Similarly, the vertical suspenders 1240 are made of a metal alloy with a lamellar microstructure in which the lamellae are orientated in a preferred direction. Consequently, the vertical suspenders have increased resistance to stress corrosion cracking.

FIG. 13 illustrates a titanium-aluminium alloy with a lamellar microstructure. The alloy has colonies 1310 in which there are alternating layers of a first phase 1320 and a further phase 1330. The alternating layers may be referred to as lamellae. The lamellae within a colony 1310 have a uniform orientation along the length of each lamella. The uniform orientation of lamellae within a colony 1310 may be referred to as the crystallographic orientation. The crystallographic orientation of different colonies is naturally random resulting in colony boundaries 1340. The crystallographic orientation of individual colonies 1310 may be aligned in a similar way to the methods described in previous embodiments. It will be appreciated that in other embodiments, the titanium-aluminium alloy may be a different alloy with a lamellar microstructure. The directionally orientated lamellae with the titanium-aluminium alloy may have a similar effect at redirecting crack propagation and improving resistance to stress corrosion cracking as is described in FIGS. 6, 8 and 9.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. An elongate wire element for supporting a tensile load at a structure, comprising:
an elongate metal alloy body comprising at least one outer surface region, that is an expected crack initiation surface region, locatable where crack propagation is expected when the metal alloy body supports a tensile load; wherein the metal alloy body is manufactured from a metal alloy that comprises at least two phases that are disposed in a lamellar formation with lamellae in each bi-crystal colony in a cross section of the metal alloy body being directionally oriented between 90° and 60° to a one predetermined direction that is parallel to a plane that contains said a cross section and in a direction orthogonal to the expected crack initiation surface region.

2. The elongate wire element as claimed in claim 1, comprising: in any selected cross section along the body, at least 60% of an area of all regions of at least a first phase of the metal alloy extend between 90° and 60° to the predetermined direction.

3. The elongate wire element as claimed in claim 1, further comprising:
in any selected cross section along the body, at least 60% of an area of at least 60% of all lamellae of the same phase in each colony extend along a common direction of orientation.

4. The elongate wire element as claimed in claim 2, wherein the predetermined direction is a direction orthogonal to a wire drawing direction and the metal alloy body is a body manufactured via a pre-drawing and/or a cold drawing.

5. The elongate wire element as claimed in claim 1, further comprising:
the metal alloy body comprises a plurality of colonies in each respective cross section at any selected point along said length and each colony in a cross section comprises material in a parallelised lamellar orientation.

6. The elongate wire element as claimed in claim 1, wherein the metal alloy is an alloy that comprises two stable phases at a temperature of between 30° C. to minus 3° C.

7. The elongate wire element as claimed in claim 1, wherein the metal alloy is an iron-carbon alloy comprising Iron (Fe) and Carbon (C) and optionally one or more alloying elements.

8. The elongate wire element as claimed in claim 7 wherein each bi-crystal colony is a pearlite colony.

9. The elongate wire element as claimed in claim 7 wherein each bi-crystal colony comprises alternating regions of a cementite phase (Fe₃C), which comprises a first phase of the metal alloy, and a ferrite (alpha phase) which comprises a further phase of the metal alloy.

10. The elongate wire element as claimed in claim 1, further comprising:
each lamellae in a cross section comprises an elongate region of a material that has a uniform composition.

11. The elongate wire element as claimed in claim 1 wherein the metal alloy body is a cold rolled body.

12. The elongate wire element as claimed in claim 1, further comprising: an average misorientation angle of each phase is less than 30°.

13. Flexible pipe body for transportation of a production fluid, comprising:
a tubular fluid retaining layer; and at least one armour layer coaxial with the fluid retaining layer;
wherein each armour layer comprises at least one helically wound elongate metal alloy body that comprises at least two phases that are disposed in a lamellar structure with lamellae in each bi-crystal colony in a cross section of the metal alloy body being directionally orientated between 90° and 60° to a one predetermined direction.

14. The flexible pipe body as claimed in claim 13, further comprising:
the armour layer comprises a first tensile armour layer that comprises a first plurality of discreet helically wound metal alloy wires that each comprise an elongate metal alloy body, each metal alloy wire in said first plurality of wires being disposed with lamellae in each bi-crystal colony, in a cross section orthogonal to a primary axis of the wire, being directionally oriented between 90° and 60° to said a one predetermined direction that comprises a direction aligned with a radial direction that is a direction directly radially outwards away from a central primary axis of the flexible pipe body.

15. The flexible pipe body as claimed in claim 14 wherein lamellae in each colony in any cross section in any wire of the first plurality of wires of the first armour layer have commonly aligned lamellae that share a direction of orientation within 30° of each other.

16. The flexible pipe body as claimed in claim 14 wherein the at least one armour layer comprises a further tensile armour layer that comprises a further plurality of discreet helically wound metal alloy wires with the lamellae in a cross section of each of the further plurality of wires that provide the further armour layer also commonly aligned whereby lamellae in each colony in any cross section along a length of a respective wire in the further plurality of wires being aligned within 30° to one another.

17. The flexible pipe body as claimed in claim 16, further comprising: the metal alloy of the wires in the first armour layer comprise lamellae directionally oriented in each colony in any cross section along a length of a respective wire that have a direction of orientation within 30° of one another and that share a common direction of orientation with the lamellae in the wires of the further armour layer.

18. A method of providing a tensile armour wire for flexible pipe body, comprising the steps of:
providing a pre-drawn bar of a metal alloy; urging the metal alloy of the pre-drawn bar via a die member thereby providing an elongate cold drawn tensile armour wire; and
varying at least one manufacturing parameter during the step of providing a pre-drawn bar and/or urging the metal alloy whereby the cold drawn wire element comprises a metal alloy that comprises at least two phases that are disposed in a lamella formation with lamellae in each bi-crystal colony in a cross section of the wire element being directionally oriented between 90° and 60° to a one predetermined direction that is aligned with a direction that comprises a direction of drawing.

19. The method as claimed in claim 18, further comprising: varying at least one manufacturing parameter by varying a strain of a metal alloy body during a pre-drawing step that provides the pre-drawn bar and/or varying a strain of a metal alloy body during the step of urging the metal alloy of the pre-drawn bar via a die member.

20. The method as claimed in claim 18, further comprising: varying at least one manufacturing parameter by varying a localised temperature applied to a metal alloy body during a pre-drawing step and/or urging a pre-drawn bar via a die member.
